(19) United States
(12) Patent Application Publication
(10) Pub. No.: US 2008/0221939 A1
(43) Pub. Date: Sep. 11, 2008

(54) METHODS FOR REWRITING AGGREGATE EXPRESSIONS USING MULTIPLE HIERARCHIES

(75) Inventors: Bishwaranjan Bhattacharjee, Yorktown Heights, NY (US); Lipyeow Lin, Hawthorne, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/682,653

(22) Filed: Mar. 6, 2007

(51) Int. Cl. G06F 17/50

(52) U.S. Cl. 705/7

(57) ABSTRACT

Key performance indicator (KPI) expressions are rewritten using metric hierarchies. A node label is associated with each node in the metric hierarchies, the metric hierarchies arranged in arbitrary trees. Node labels associated with each term in a KPI expression are retrieved, and the terms in the KPI expression are sorted according to the node labels. The terms are grouped according to the node labels, and a collection of groups that covers all the terms in the KPI expression is found. Overlaps in the covering groups may be minimized.

### BACKGROUND

The present invention relates generally to data warehousing, and more specifically, to rewriting expressions using metric hierarchies.

In many scenarios where warehouses are deployed, businesses define many hierarchies for various intelligence metrics, commonly referred to as “business intelligence” (BI) metrics. Examples of such hierarchies include organizational hierarchies, customer hierarchies, and accounting hierarchies. In general, the leaf nodes of these hierarchies are associated with tables or columns in the data warehouse. To support BI reporting, a large number of complex business metrics, such as key performance indicator (KPIs), are specified as mathematical expressions (summations or subtractions) over the leaf nodes. To compute these complex business metrics, the values in the tables or columns associated with the leaf nodes used in the expressions are retrieved, and the expressions are evaluated.

There are two problems with this scenario. First, there are a large number of expressions, and each expression contains a large number of terms, resulting in a large storage requirement to make these expressions persist. Second, often the metric hierarchies contain partial computations that could be exploited in the evaluation of the expressions. However current systems do not know how to exploit these partial computations.

Accordingly, there is a need for a technique for discovering the relationships between KPI expressions and metric hierarchies.

### SUMMARY

According to an exemplary embodiment, a method is provided for rewriting key performance indicator (KPI) expressions using metric hierarchies. The method comprises associating a node label to each node in the metric hierarchies, wherein the metric hierarchies are arranged in arbitrary trees. The method further comprises retrieving node labels associated with each term in a KPI expression, sorting the terms in the KPI expression according to the node labels, grouping the terms into a plurality of groups according to the node labels, finding a collection of groups that cover all the terms in the KPI expression, and minimizing overlaps in the covering groups.

### BRIEF DESCRIPTION OF THE DRAWINGS

Referring to the exemplary drawings wherein like elements are numbered alike in the several Figures:

FIG. 1 illustrates two exemplary metric hierarchies, an exemplary KPI expression, and an exemplary re-written KPI expression according to an exemplary embodiment;

FIG. 2 is a flowchart depicting exemplary steps of a method for rewriting a KPI expression using metric hierarchies according to an exemplary embodiment;

FIG. 3 illustrates intermediate results generated by different steps in a method for rewriting a KPI expression using metric hierarchies according to an exemplary embodiment.

### DETAILED DESCRIPTION

According to an exemplary embodiment, a method is provided for rewriting a KPI expression including an arithmetic expression of terms (associated with leaf nodes in the metric hierarchies) using the internal nodes of the metric hierarchies. The KPI expressions are rewritten using the subtrees within the metric hierarchies. This results in a KPI expression that is a much more compact representation than the conventional KPI expression, thus saving storage space. In addition, exemplary embodiments provide the ability to exploit precomputed partial results from the metric hierarchies during the evaluation of the KPI expression.

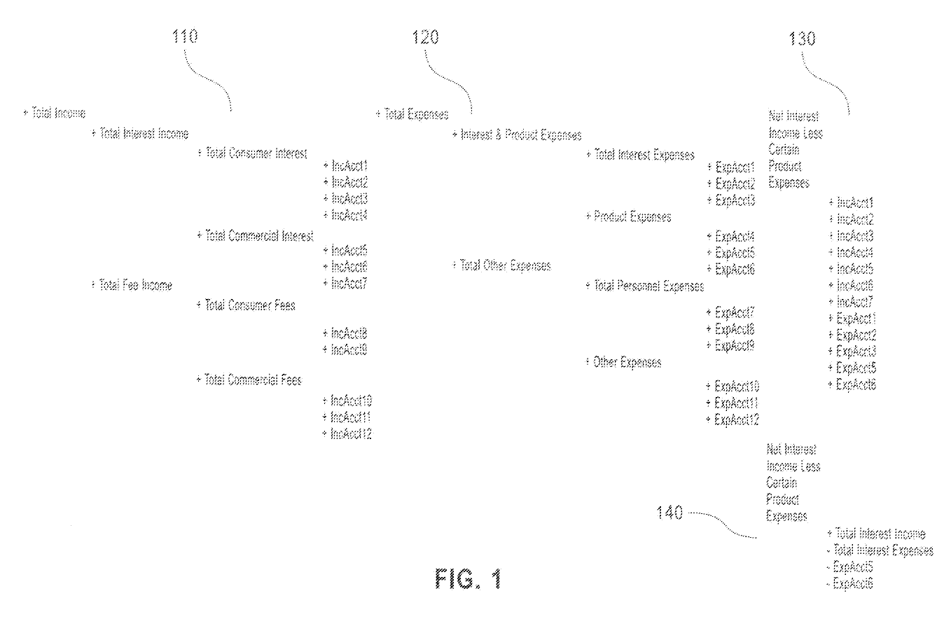

FIG. 1 illustrates to various exemplary metric hierarchies, including an exemplary conventional KPI expression, and exemplary re-written KPI expression according to an exemplary embodiment. Reference numeral 110 points to an exemplary metric hierarchy for income, and reference numeral 120 points to an exemplary metric hierarchy for expenses. The leaf nodes of these hierarchies are associated with accounts. Reference numeral 130 points to an exemplary KPI expression that sums a list of terms and subtracts a list of terms in the metric hierarchies 110 and 120. Reference numeral 140 points to the same KPI expression after it has been rewritten according to an exemplary embodiment. As can be seen by comparing the KPI expressions 130 and 140, the rewritten expression 140 has a fewer number of terms and includes terms that are associated with internal nodes of the metric hierarchies.

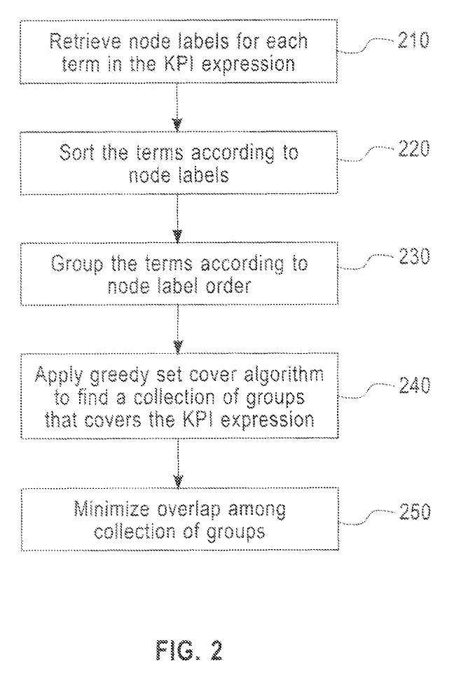

FIG. 2 illustrates a method for rewritting a KPI expression according to an exemplary embodiment. The method described herein is applicable to a collection of arbitrary hierarchies. A hierarchy is a tree. Each node in the tree can be associated with a node name. In addition, a node labeling technique may be used to associate labels with each node. Although not shown, a preprocessing step may be performed, wherein the metric hierarchies are scanned, and each node is annotated with labels. Any labeling scheme that preserves ancestor-descendant relationships can be used. Details of an exemplary labeling scheme that may be used are provided in Tatarinov, I., et al., “Storing and querying ordered XML using a relational database system”, Proc. of SIGMOD, pp. 204-215, 2002.

Referring to FIG. 2, given a KPI expression, node labels associated with each term in the expression are retrieved at strep 210. In step 220, the terms of the expression are sorted according to the node label order. In step 230, terms that share the same ancestor are grouped together according to node label order. After step 230, there may be many overlapping groups. In step 240, any “greedy” set cover algorithm can be used to find a collection of groups that covers all the terms in the KPI expression. As those skilled in the art will appreciate, a “greedy” set may be considered a set covering the largest number of uncovered members. The set cover problem is to find a minimum size set. Further details of a “greedy” set cover algorithm may be found in “Introduction to Algorithms” by Thomas Cormen et al., 2d. ed., 2001. After step 240, the groups in the covering collection may contain overlapping groups. In step 250, the overlapping between groups may be minimized.

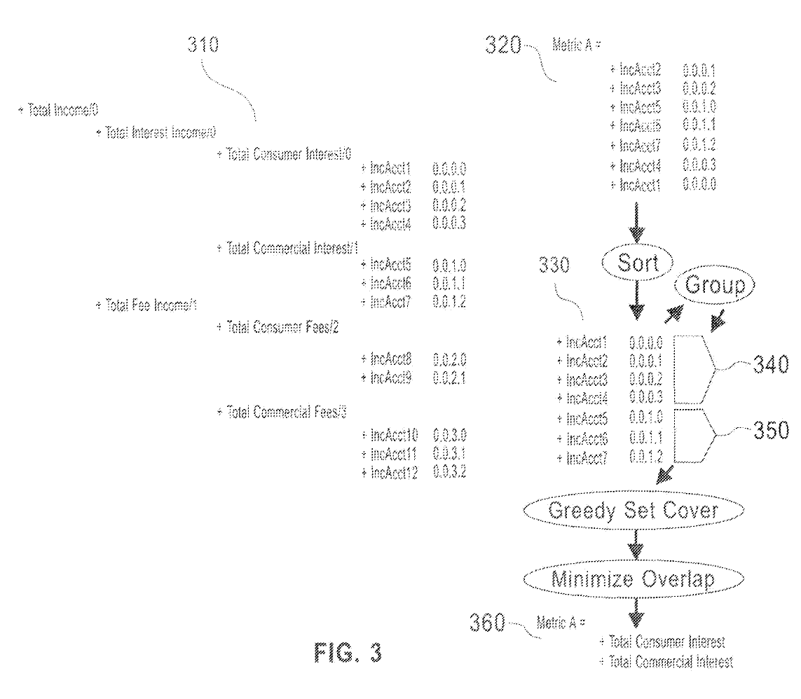

FIG. 3 illustrates an exemplary data set that may be produced as a result of a method for rewriting a KPI expression according to an exemplary embodiment. Two exemplary hiearachies are identified by reference numeral 310. The rightmost column referenced by reference numeral 310 shows the dewey node labels associated with each leaf node in the hierarchies. Exemplary KPI expressions are identified by reference numeral 320. The rightmost column referenced by reference numeral 320 shows the dewey labels retrieved for each term in the expression after step 210 is performed, as explained above with reference to FIG. 2. As explained above, the terms are sorted, e.g., according to a dewey labeling prefix order in step 220, and the sorted terms are identified in FIG. 3 by reference numeral 330. The sorted terms are then grouped into two groups, identified in FIG. 3 by reference numerals 340 and 350. In the example shown in FIG. 3, the two groups 340 and 350 already form a covering set. If needed, though, a greedy set cover algorithm may be used to find the covering set. Overlap may then me minimized to produce an improved KPI expression 360.

While the invention has been described with reference to exemplary embodiments, it will be understood by those skilled in the art that various changes may be make and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for rewriting key performance indicator (KPI) expressions using metric hierarchies, comprising:
associating a node label to each node in the metric hierarchies, wherein the metric hierarchies are arranged in arbitrary trees;
retrieving node labels associated with each term in a KPI expression;
sorting the terms in the KPI expression according to the node labels;
grouping the terms into a plurality of groups according to the node labels;
finding a collection of groups that cover all the terms in the KPI expression; and
minimizing overlaps in the covering groups.

2. The method of claim 1, wherein the metric hierarchies are business intelligence metrics.

3. The method of claim 1, wherein in the metric hierarchies include at least one or organizational hierarchies, customer hierarchies, and accounting hierarchies.

4. The method of claim 1, wherein the step of finding a collection of groups includes applying a greedy set covering algorithm.
